(19) United States
(12) Patent Application Publication
(10) Pub. No.: US 2023/0339120 A1
(43) Pub. Date: Oct. 26, 2023

(54) ROBOT APPARATUS, METHOD FOR CONTROLLING ROBOT APPARATUS, IMAGE PROCESSING APPARATUS, IMAGE PROCESSING METHOD, METHOD FOR MANUFACTURING PRODUCT, AND RECORDING MEDIUM

(71) Applicant: CANON KABUSHIKI KAISHA, Tokyo (JP)

(72) Inventor: TOMOHIRO IZUMI, Kanagawa (JP)

(21) Appl. No.: 18/299,789

(22) Filed: Apr. 13, 2023

(30) Foreign Application Priority Data
Apr. 25, 2022 (JP) 2022-071245

(51) Int. Cl. B25J 9/16

(52) U.S. Cl. CPC B25J 9/1697; B25J 9/1633

(57) ABSTRACT

A robot apparatus includes a robot, an image pickup portion, and a controller configured to control the robot. The controller obtains information about force by comparing a predetermined image with a captured image obtained by the image pickup portion imaging the robot, and performs force control of the robot on a basis of the information about force.

### BACKGROUND OF THE INVENTION

### Field of the Invention

The present disclosure relates to robot technology.

### Description of the Related Art

A visual servo technique that feedbacks visual information obtained by a visual sensor such as a camera to a motion control system of a robot is known. A visual servo is constituted by a full closed loop control system that controls the robot such that visual deviation is reduced. Therefore, the robot can be positioned with high precision without calibrating external parameters of the camera. In addition, since the robot is controlled on the basis of visual information, environmental change such as variation in the position of a target object can be flexibly addressed. Therefore, research and development for improving the efficiency of work where the variation in the position of the target object is large has been accelerating.

A conventional visual servo controls, on the basis of visual deviation, the position and speed of a tool provided on a robot. Therefore, for example, in the case of performing a work involving contact such as assembly of parts by using just the visual servo, the robot brings a part into contact with a target object by position control or speed control that has a high servo rigidity.

Meanwhile, force control is provided as control for suppressing an excessive force acting on a part in a work involving contact. The force control is a control method of detecting a force acting on a robot or a tool and controlling the force. In industrial robots, impedance control in which a desired mechanical impedance is imparted to a tool is widely employed as force control. In a work under such force control of a robot, in many cases, a tool or a workpiece needs to be roughly positioned at a predetermined position where the work is performed. For example, in an assembly work of a male part and a female part, the male part is positioned at an entrance of the female part.

Regarding this, a method of causing the robot to approach the predetermined position by a visual servo and then switching to the force control at the predetermined position and causing the robot to perform the assembly can be considered. Japanese Patent Laid-Open No. 2013-180380 discloses a robot apparatus in which a force control system is incorporated in a visual servo system and which controls a robot on the basis of a positional relationship between an attaching part and an attached part.

### SUMMARY OF THE INVENTION

According to a first aspect of the present disclosure, a robot apparatus includes a robot, an image pickup portion, and a controller configured to control the robot. The controller obtains information about force by comparing a predetermined image with a captured image obtained by the image pickup portion imaging the robot, and performs force control of the robot on a basis of the information about force.

According to a second aspect of the present disclosure, a method for controlling a robot apparatus, the method includes obtaining information about force by comparing a predetermined image with a captured image obtained by an image pickup portion imaging a robot, and performing force control of the robot on a basis of the information about force.

According to a third aspect of the present disclosure, an image processing apparatus is configured to obtain information about force for performing force control of a robot. The image processing apparatus includes a controller configured to obtain the information about force by comparing a predetermined image with a captured image obtained by an image pickup portion imaging the robot.

According to a fourth aspect of the present disclosure, an image processing method for obtaining information about force for performing force control of a robot is provided. The image processing method includes obtaining the information about force by comparing a predetermined image with a captured image obtained by an image pickup portion imaging the robot.

Further features of the present invention will become apparent from the following description of exemplary embodiments with reference to the attached drawings.

### BRIEF DESCRIPTION OF THE DRAWINGS

FIG. 1 is a schematic view of a robot apparatus according to an embodiment.

FIG. 2 is a block diagram illustrating a control system of the robot apparatus according to the embodiment.

FIG. 3 is a schematic view of a work environment of the robot apparatus according to the embodiment.

FIG. 4A is a schematic diagram for describing an assembly work according to the embodiment.

FIG. 4B is a schematic diagram for describing the assembly work according to the embodiment.

FIG. 5 is an explanatory diagram of a user interface (UI) image according to the embodiment.

FIG. 6 is a flowchart illustrating processing in which setting information according to the embodiment is set.

FIG. 7 is an explanatory diagram illustrating a goal image according to the embodiment.

FIG. 8A is an explanatory diagram of a UI image according to the embodiment.

FIG. 8B is an explanatory diagram of a UI image according to the embodiment.

FIG. 9A is an explanatory diagram of a UI image according to the embodiment.

FIG. 9B is an explanatory diagram of a UI image according to the embodiment.

FIG. 10A is an explanatory diagram of a UI image according to the embodiment.

FIG. 10B is an explanatory diagram of a UI image according to the embodiment.

FIG. 11A is an explanatory diagram of a UI image according to the embodiment.

FIG. 11B is an explanatory diagram of a UI image according to the embodiment.

FIG. 12A is an explanatory diagram of a UI image according to the embodiment.

FIG. 12B is an explanatory diagram of a UI image according to the embodiment.

FIG. 13A is an explanatory diagram of a UI image according to the embodiment.

FIG. 13B is an explanatory diagram of a UI image according to the embodiment.

FIG. 14 is a flowchart illustrating force control for performing the assembly work according to the embodiment.

FIG. 15A is a block line diagram of control according to the embodiment.

FIG. 15B is a block line diagram of control according to the embodiment.

FIG. 16A is an explanatory diagram of a camera image display portion displaying a state of the assembly work according to the embodiment.

FIG. 16B is an explanatory diagram of the camera image display portion displaying a state of the assembly work according to the embodiment.

FIG. 16C is an explanatory diagram of the camera image display portion displaying a state of the assembly work according to the embodiment.

FIG. 17A is an explanatory diagram of the camera image display portion displaying a state of the assembly work according to the embodiment.

FIG. 17B is an explanatory diagram of the camera image display portion displaying a state of the assembly work according to the embodiment.

FIG. 17C is an explanatory diagram of the camera image display portion displaying a state of the assembly work according to the embodiment.

### DESCRIPTION OF THE EMBODIMENTS

When causing a robot to perform an actual work, it is not always the case that the environment has a good workability for the robot. For example, an obstacle is present within a work area where the robot performs a work. Even in such a situation, the workability for the robot is desired to be improved.

The present disclosure improves the workability for the robot.

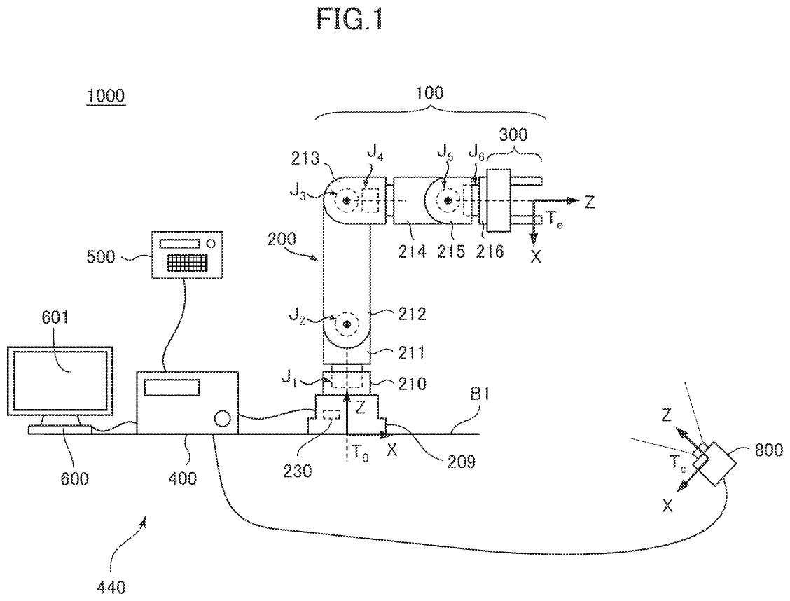

An exemplary embodiment of the present disclosure will be described in detail below with reference to drawings. FIG. 1 is a schematic view of a robot apparatus 1000 according to the embodiment. The robot apparatus 1000 includes a robot 100, a servo controller 230, a control apparatus 400, an input device 500, a display 600, and a visual sensor 800.

The control apparatus 400 is an apparatus that controls the operation of the robot 100. The input device 500 is a device that a user can operate to input various kinds of information. The display 600 is an example of a display portion, and is capable of displaying various images on a display screen 601. The visual sensor 800 is an example of an image pickup portion, and is, for example, a digital camera. The visual sensor 800 is a two-dimensional camera, and is capable of obtaining two-dimensional image information by imaging an object. To be noted, the visual sensor 800 is not limited to a two-dimensional camera, and may be, for example, a three-dimensional camera.

The robot 100 is, for example, an industrial robot, and includes a robot arm 200 and a robot hand 300. The robot 100 is provided in a manufacturing line, and is used for manufacturing a product. The work for manufacturing the product includes, for example, a work of gripping a first workpiece by the robot hand 300 and operating the robot arm 200 to couple the first workpiece to a second workpiece. In addition, the work for manufacturing the product includes a conveyance work, an assembly work, a processing work, and a coating work. Examples of the processing work includes a cutting work, a grinding work, a polishing work, and a sealing work. An end effector corresponding to the work, which is the robot hand 300 in the example of the present embodiment, is attached to the robot arm 200.

In the present embodiment, the robot arm 200 is a vertically-articulated robot arm. A proximal end, that is, a fixed end of the robot arm 200, is disposed on a stage B1. The robot hand 300 is attached to a distal end, that is, a free end of the robot arm 200 serving as a predetermined position.

The robot arm 200 includes a base 209, a plurality of links 210 to 216, and a plurality of joints J₁ to J₆. The plurality of links 210 to 216 are connected in serial in this order via the plurality of joints J₁ to J₆. The plurality of joints J₁ to J₆ will be respectively referred to as a first joint J₁, a second joint J₂, a third joint J₃, a fourth joint J₄, a fifth joint J₅, and a sixth joint J₆ in this order from the link 210 side serving as the proximal end side toward the link 216 side serving as the distal end side of the robot arm 200. The link 210 serving as a proximal end portion of the robot arm 200 is fixed to the base 209. The base 209 is fixed to the upper surface of the stage B1. The links 211 to 216 are respectively rotationally driven by the joints J₁ to J₆. As a result of this, the robot arm 200 can adjust the robot hand 300 to an arbitrary position in three-axis directions and an arbitrary orientation in three-axis directions.

The robot hand 300 is provided at a predetermined part of the robot arm 200, for example, the link 216 serving as a distal end portion. That is, the link 216 is a support portion configured to support an end effector such as the robot hand 300.

The posture of the robot arm 200 can be expressed in a coordinate system. A coordinate system Tₒ in FIG. 1 is a coordinate system set for the stage B1 to which the robot arm 200 is fixed. A coordinate system Tₑ is a coordinate system set for the robot hand 300. The coordinate system Tₑ expresses a tool center position: TCP. For example, the coordinate system Tₑ is set for the robot hand 300. For example, the coordinate systems Tₒ and Tₑ are each a three-axis orthogonal coordinate system constituted by X, Y, and Z axes.

A coordinate system T_{c} is a coordinate system set with respect to the visual sensor 800, expressed as a three-axis orthogonal coordinate system constituted by the X, Y, and Z axes similarly to the coordinate systems Tₒ and Tₑ, and set such that the optical axis direction of the visual sensor 800 coincides with the Z-axis direction. To be noted, although a case where the visual sensor 800 is fixed to a predetermined position set with respect to the coordinate system Tₒ, for example, to the stage B1 will be described in the present embodiment, the visual sensor 800 may be fixed to the robot arm 200 or the robot hand 300.

The control apparatus 400 is capable of controlling the operation, that is, the posture of the robot arm 200. The servo controller 230, the input device 500, the display 600, and the visual sensor 800 are connected to the control apparatus 400. For example, if the input device 500 is a teaching pendant, the worker, that is, the user can use the input device 500 for teaching the operation of the robot arm 200.

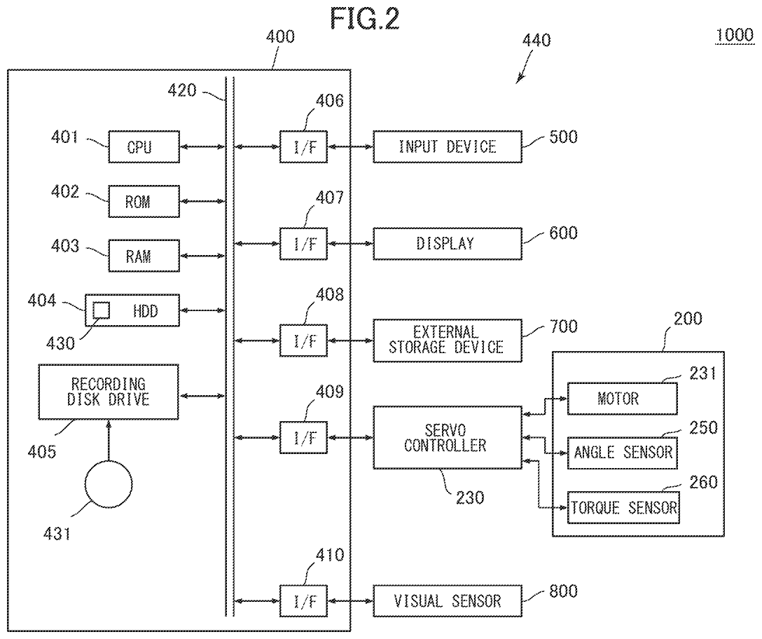

The servo controller 230 controls the driving of a motor 231 of each of the joints J₁ to J₆ illustrated in FIG. 2. For example, the servo controller 230 is disposed inside the base 209. To be noted, the position where the servo controller 230 is disposed is not limited to the inside of the base 209, and the servo controller 230 may be disposed anywhere. For example, the servo controller 230 may be disposed inside the casing of the control apparatus 400. That is, the servo controller 230 may be part of elements of the control apparatus 400. In the present embodiment, the input device 500, the display 600, the visual sensor 800, the control apparatus 400, and the servo controller 230 constitute a control system 440. The control system 440 is also an example of an image processing apparatus.

The servo controller 230 controls driving of the motor 231 of each of the joints J₁ to J₆ on the basis of respective command values obtained from the control apparatus 400 and respectively corresponding to the joints J₁ to J₆, such that the angle or torque of each of the joints J₁ to J₆ follows a command value. That is, the servo controller 230 is configured to be capable of performing position control or torque control of each joint of the robot 100.

FIG. 2 is a block diagram illustrating the control system 440 of the robot apparatus 1000 according to the embodiment. The joints J₁ to J₆ each include a motor 231, an angle sensor 250, and a torque sensor 260. To be noted, FIG. 2 illustrates a configuration of one of the plurality of joints J₁ to J₆ as a representative.

The control apparatus 400 is constituted by a computer. The control apparatus 400 includes a central processing unit: CPU 401 serving as a processor.

In addition, the control apparatus 400 includes a read-only memory: ROM 402, a random access memory: RAM 403, and a hard disk drive: HDD 404 as examples of storage portions. In addition, the control apparatus 400 includes a recording disk drive 405, and a plurality of input/output interfaces (I/Fs) 406 to 410.

The CPU 401 is connected to the ROM 402, the RAM 403, the HDD 404, the recording disk drive 405, and the interfaces 406 to 410 via a bus 420. The ROM 402 stores a basic program such as a basic input output system: BIOS. The RAM 403 is a storage device that temporarily stores various data such as results of arithmetic processing by the CPU 401.

The HDD 404 is a storage device that stores results of arithmetic processing by the CPU 401, various data obtained from the outside, and the like. The HDD 404 stores a program 430 for causing the CPU 401 to execute arithmetic processing. The CPU 401 executes each processing of an image processing method that is a control method that will be described later, that is, a manufacturing method for the product, on the basis of the program 430 recorded (stored) in the HDD 404. The recording disk drive 405 is capable of reading out various data, programs, and the like recorded in a recording disk 431.

The interface 406 is connected to the input device 500. The CPU 401 obtains input data, that is, input information from the input device 500 via the interface 406 and the bus 420. The interface 407 is connected to the display 600. The display 600 displays various images under the control of the CPU 401. The interface 408 is configured to be connectable to an external storage device 700 that is a storage portion such as a rewritable nonvolatile memory, an external HDD, or the like.

The servo controller 230 is connected to the interface 409. The servo controller 230 is connected to the motor 231, the angle sensor 250, and the torque sensor 260 of each of the joints J₁ to J₆ of the robot arm 200. The motor 231 is, for example, a brushless direct current motor: DC motor or an alternate current motor: AC motor, and rotationally drives a corresponding one of the joints J₁ to J₆ via an unillustrated reduction gear. The angle sensor 250 is, for example, a rotary encoder, is provided at the motor 231, and is configured to be capable of detecting the rotational angle of the motor 231. The torque sensor 260 is provided at a corresponding one of the joints J₁ to J₆, and is configured to be capable of detecting the torque acting on the corresponding one of the joints J₁ to J₆.

The CPU 401 is capable of obtaining angle information from the angle sensor 250 and obtaining torque information from the torque sensor 260 via the servo controller 230, the interface 409, and the bus 420. The servo controller 230 may divide the angle of the motor 231 detected by the angle sensor 250 by a reduction ratio of the unillustrated reduction gear to convert the angle into angle information of the corresponding joint, and transmit the angle information to the CPU 401.

The CPU 401 outputs data of command values corresponding to the joints J₁ to J₆ to the servo controller 230 via the bus 420 and the interface 409 at a predetermined time interval (for example, 1 ms).

The interface 410 is connected to the visual sensor 800, and the visual sensor 800 performs imaging at a predetermined time interval (for example, 30 ms) under the control of the CPU 401. As a result of this, the CPU 401 can obtain visual information, that is, data of a captured image from the visual sensor 800 at a predetermined time interval (for example, 30 ms).

The HDD 404 is also a non-transitory computer-readable recording medium. Although the program 430 is stored in the HDD 404 in the present embodiment, the configuration is not limited to this. The program 430 may be recorded in any recording medium as long as the recording medium is a non-transitory computer-readable recording medium. For example, as the recording medium for supplying the program 430, flexible disks, hard disks, optical disks, magneto-photo disks, magnetic tapes, and nonvolatile memories can be used. Examples of the optical disks include disk media such as Blu-ray disks, digital versatile disks: DVDs, and compact disks: CDs. Examples of the nonvolatile memories include storage devices such as universal serial bus memories: USB memories, memory cards, ROMs, and SSDs.

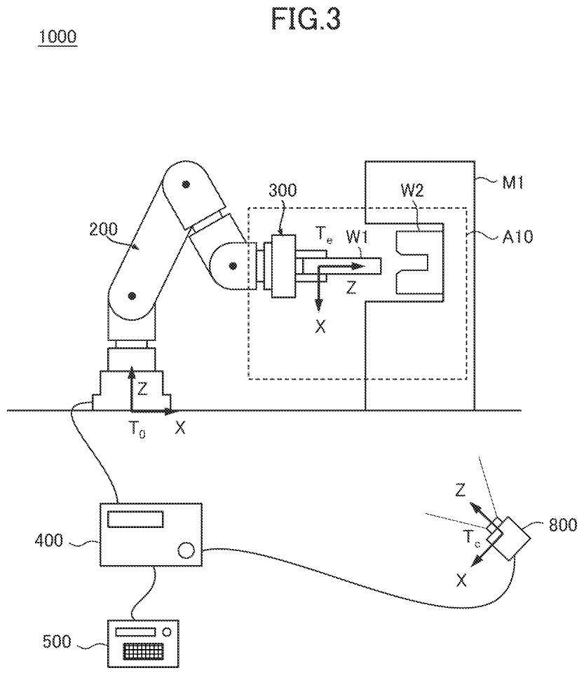

Next, the work environment in the present embodiment will be described. FIG. 3 is a schematic view of the work environment of the robot apparatus 1000 according to the present embodiment. In the present embodiment, a case where the predetermined work that the robot 100 performs is a work of coupling a workpiece W1 gripped by the robot hand 300 to a workpiece W2 fixed to a workpiece fixing jig M1 will be described. A region A10 indicated by a broken line in FIG. 3 indicates a region imaged by the visual sensor 800. As illustrated in FIG. 3, the robot 100 can hold the workpiece W1 by gripping the workpiece W1 by the robot hand 300. The workpiece W1 is an example of a held object. In addition, the workpiece W1 is an example of a first workpiece, and the workpiece W2 is an example of a second workpiece.

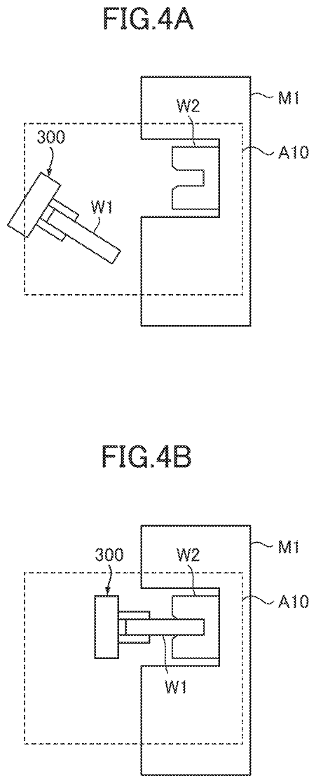

FIGS. 4A and 4B are each a schematic diagram of the assembly work according to the embodiment. FIG. 4A illustrates an initial state of the workpiece W1. FIG. 4B illustrates a state in which coupling of the workpiece W1 to the workpiece W2 is complete. The work of coupling the workpiece W1 to the workpiece W2 is performed by controlling the robot arm 200 such that the workpiece W1 transitions from the initial state illustrated in FIG. 4A to the assembly completion state illustrated in FIG. 4B.

Here, when teaching the assembly completion state of the workpiece W1, the robot hand 300 is operated to the assembly completion state illustrated in FIG. 4B. The operation of the robot hand 300 may be performed by the user back-driving the robot arm 200, or the user may directly operate the robot hand 300 by detaching the robot hand 300 from the robot arm 200.

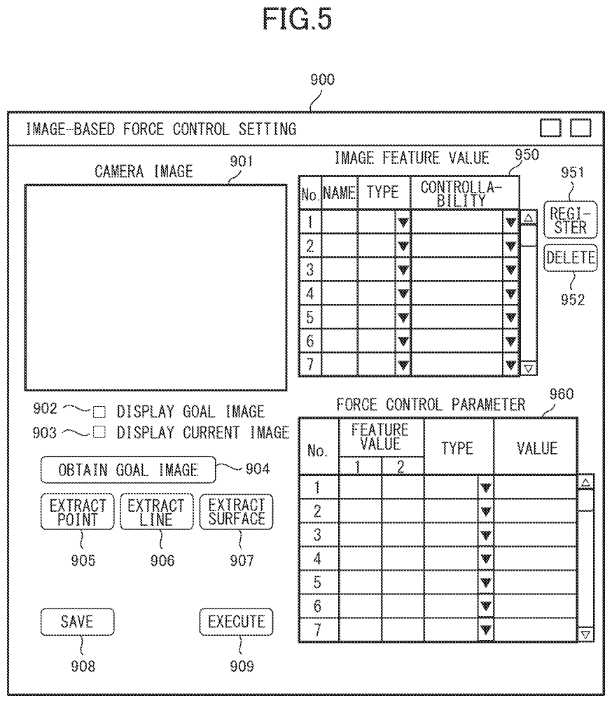

FIG. 5 is an explanatory diagram of a user interface image: UI image 900 according to the embodiment. The UI image 900 is an example of a second user interface image, and is an image for receiving setting of a feature portion that will be described later. The CPU 401 of the control apparatus 400 executes the program 430, and thus displays the UI image 900 of FIG. 5 on the display screen 601 of the display 600 illustrated in FIG. 1. The user can operate the UI image 900 by using the input device 500. The user can perform various settings related to the assembly work of the workpieces W1 and W2 via the UI image 900.

The UI image 900 includes a camera image display portion 901, a goal image display checkbox 902, a current image display checkbox 903, a goal image obtaining button 904, a point extraction button 905, a line extraction button 906, and a surface extraction button 907. In addition, the UI image 900 includes a saving button 908, an execution button 909, a list display portion 950, a registration button 951, a deletion button 952, and a parameter display portion 960. That is, the CPU 401 displays, in the UI image 900, the camera image display portion 901, the goal image display checkbox 902, the current image display checkbox 903, the goal image obtaining button 904, the point extraction button 905, the line extraction button 906, and the surface extraction button 907. In addition, the CPU 401 displays, in the UI image 900, the saving button 908, the execution button 909, the list display portion 950, the registration button 951, the deletion button 952, and the parameter display portion 960.

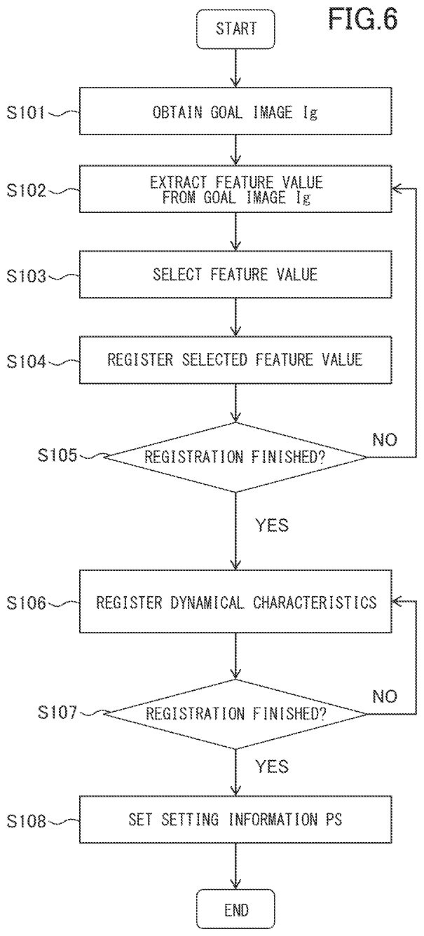

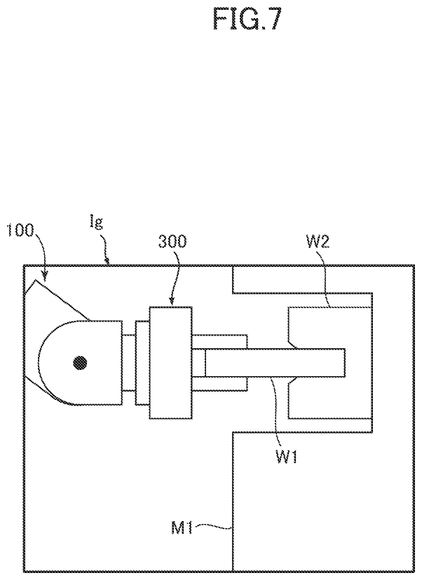

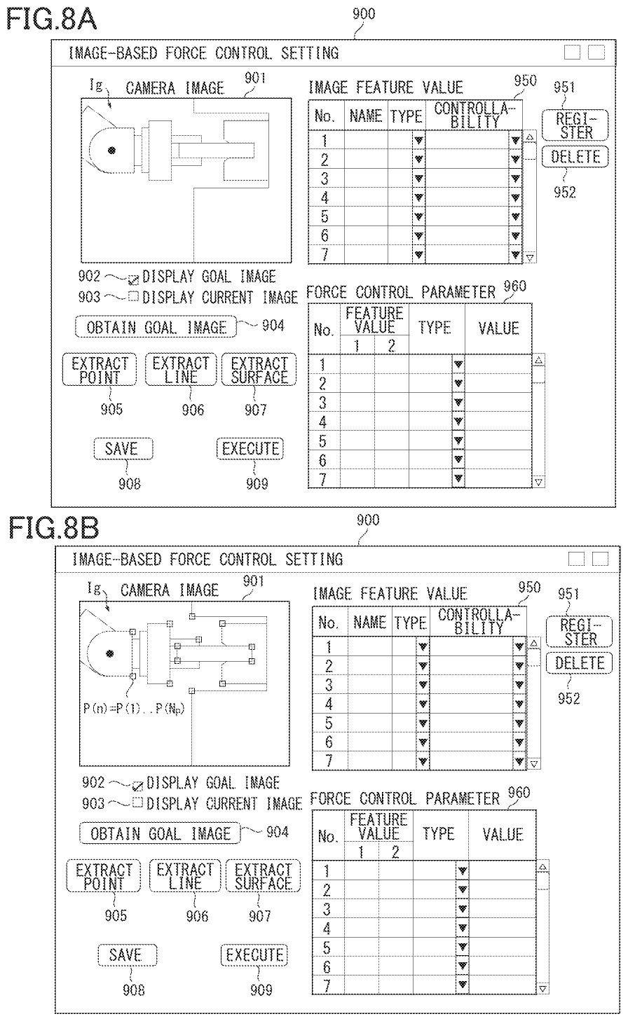

FIG. 6 is a flowchart illustrating processing in which setting information according to the embodiment is set. The CPU 401 executes processing following the flowchart illustrated in FIG. 6, by executing the program 430. FIG. 7 is an explanatory diagram illustrating a goal image according to the embodiment. FIGS. 8A to 13B are explanatory diagrams of the UI image according to the embodiment.

In step S101, when the goal image obtaining button 904 is operated by the user, the CPU 401 obtains a goal image Ig illustrated in FIG. 7 serving as an example of a predetermined image from the visual sensor 800. To be noted, the goal image Ig may be obtained from the HDD 404, an external storage device 700, or from a network. For example, the goal image Ig is temporarily stored in the RAM 403. The goal image Ig is image data serving as visual information obtained by imaging the assembly completion state illustrated in FIG. 4B. That is, the goal image Ig includes images of a control target object such as the robot 100 and the workpiece W1 in a predetermined posture, and an obstacle such as the workpiece fixing jig M1. That is, the goal image Ig is a captured image obtained by the visual sensor 800 imaging the robot 100, the workpiece W1, and the workpiece W2 in a goal posture serving as a predetermined posture in which the workpiece W1 is coupled to the workpiece W2.

When the goal image Ig is obtained, the CPU 401 checks the goal image display checkbox 902 and displays the goal image Ig in the camera image display portion 901 as illustrated in FIG. 8A. To be noted, the goal image display checkbox 902 can be also operated by the user. The CPU 401 can switch whether or not to display the goal image Ig in the camera image display portion 901 in accordance with whether or not the goal image display checkbox 902 is checked.

The point extraction button 905, the line extraction button 906, and the surface extraction button 907 are examples of first buttons. In step S102, when the point extraction button 905, the line extraction button 906, or the surface extraction button 907 is operated, the CPU 401 obtains a feature value corresponding to the operated button from the goal image Ig. The feature value in the image, that is, an image feature value is a feature portion such as a feature point, a feature line, or a feature surface.

FIG. 8B illustrates a case where the point extraction button 905 is operated by the user. In step S102, when the point extraction button 905 is operated by the user, the CPU 401 extracts, from the goal image Ig and as a feature value, feature points P(n)=P(1) to P(N_{P}). The feature points P(1) to P(N_{P}) are candidates of a feature portion to be set, that is, feature candidates.

The feature points P(n) are points where the change in the brightness or color is large in the goal image Ig, and can be extracted by, for example, accelerated-KAZE: AKAZE algorithm. Nₚ is the number of extracted feature points. To be noted, the algorithm for extracting the feature points is not limited to AKAZE, and may be, for example, scale-invariant feature transform: SIFT, speed-upped robust feature: SURF, or oriented features from accelerated segment test and rotated binary robust independent elementary features: ORB.

Then, as illustrated in FIG. 8B, the CPU 401 displays figures indicating the feature points P(1) to P(N_{P}) such that the figures are superimposed on the goal image Ig displayed in the camera image display portion 901. The figures indicating the feature points P(1) to P(N_{P}) are, for example, quadrangles.

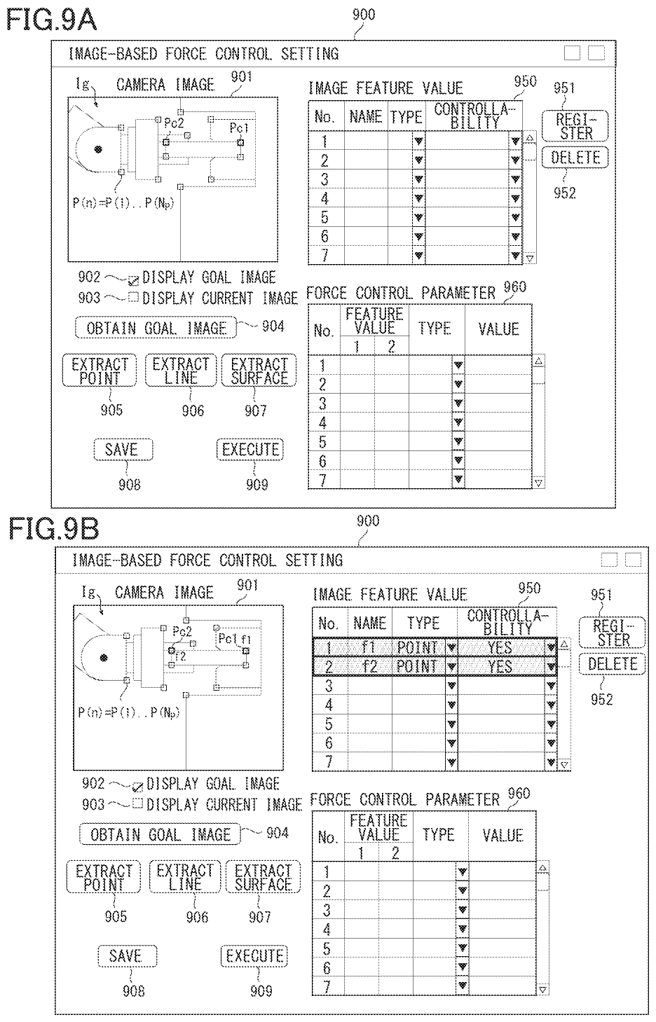

In step S103, the CPU 401 stands by for selection of any one of the feature points P(1) to P(N_{P}) by the user. The figures indicating the feature points P(1) to P(N_{P}) in the camera image display portion 901 can be selected by the user. When any one of the figures of the feature points is selected by the user in the camera image display portion 901, the CPU 401 displays the selected figure in an emphasized manner as illustrated in FIG. 9A, and sets the feature point corresponding to the selected figure as a feature point to be set. That is, the user can select a feature point from the plurality of feature points P(1) to P(N_{P}) via the UI image 900. The emphasized display of the figure includes, for example, displaying the figure in a thick line or displaying the figure in a different color from the figures of the other feature points. In FIG. 9A, feature points Pc1 and Pc2 are selected feature points.

In step S104, the CPU 401 stands by for operation of the registration button 951 by the user. When the registration button 951 is operated by the user, the CPU 401 displays information of the selected feature points Pc1 and Pc2 in the list display portion 950 as illustrated in FIG. 9B, and temporarily stores the information of the selected feature points Pc1 and Pc2 in the RAM 403. In the present embodiment, registering information refers to temporarily storing the information in the RAM 403.

The registered information includes, for example, information of a number, information of a name, information of a type, information of controllability, and information of a feature descriptor. The number is a number assigned in the order of registration. The name is a unique name given to the registered feature point. The CPU 401 automatically sets f1 to fnr as names in the order of registration, and nr represents a registration number. For example, “f1” is given to the feature point Pc1, and “f2” is given to the feature point Pc2. In the camera image display portion 901, “f1” is displayed near the figure corresponding to the feature point Pc1, and “f2” is displayed near the figure corresponding to the feature point Pc2. To be noted, the name may be modifiable by the user.

Examples of the type include a point, a line, and a surface, and the user can select one of these from a pull-down list. To be noted, in the case where the registration button 951 is operated in a state in which a feature point is selected as a feature value, the CPU 401 automatically selects “Point” as the type. In addition, in the case where the registration button 951 is operated in a state in which a feature line is selected as a feature value, the CPU 401 automatically selects “Line” as the type. Further, in the case where the registration button 951 is operated in a state in which a feature surface is selected as a feature value, the CPU 401 automatically selects “Surface” as the type.

The controllability is a value indicating whether or not the selected feature value can be controlled together with the robot 100, and the user can select “Yes” or “No” from a pull-down list. “Yes” corresponds to a control target object that can be moved by controlling the robot 100, such as the robot 100 and the workpiece W1 held by the robot 100. “No” corresponds to an obstacle that cannot be moved by controlling the robot 100. The feature points Pc1 and Pc2 are feature values associated with the workpiece W1 gripped by the robot hand 300. Therefore, the user selects “Yes” as the controllability.

The feature descriptor is an internal parameter for the CPU 401 to obtain coordinates corresponding to the registered feature value from the image obtained from the visual sensor 800, and is not displayed in the list display portion 950.

In addition, the CPU 401 displays an image indicating the feature value selected by the user in an emphasized manner among registered feature values in the UI image 900. For example, a case where the selected feature values are the feature points Pc1 and Pc2 will be described. In the camera image display portion 901, the figure to which “f1” is given and the figure to which “f2” is given are displayed in an emphasized manner by a thick line or the like. In addition, in the list display portion 950, the whole row where the information of the feature point Pc1 is displayed and the whole row where the information of the feature point Pc2 is displayed are each displayed in an emphasized manner by being surrounded by a thick frame or the like.

In step S105, the CPU 401 determines whether or not registration of a feature value or feature values required for the assembly work has been finished. In the case where the registration is not finished, that is, in the case where the result of step S105 is NO, the CPU 401 repeats the processing of steps S102 to S104. In the case where the registration is finished, that is, in the case where the result of step S105 is YES, the CPU 401 proceeds to the processing of step S106.

A case where a control target object is registered has been described above. Since a situation in which the control target object comes into contact with an obstacle needs to be avoided, a case where an obstacle is registered will be described. Here, the control target object is the workpiece W1 or the robot 100 in the example of the present embodiment. The obstacle is the workpiece fixing jig M1 in the example of the present embodiment.

In step S102, when the line extraction button 906 is operated by the user, the CPU 401 extracts, from the goal image Ig and as a feature value, feature lines L(n)=L(1) to L(N_{L}). The feature lines L(1) to L(N_{L}) are candidates of a feature portion to be set, that is, feature candidates.

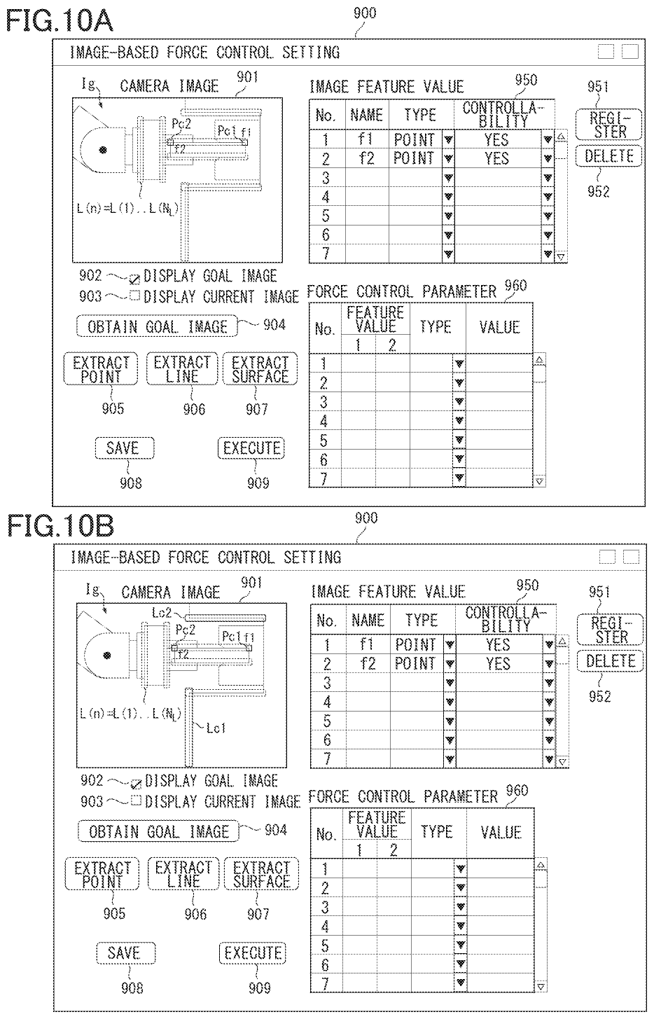

Then, as illustrated in FIG. 10A, the CPU 401 displays figures indicating the feature lines L(1) to L(N_{L}) such that the figures are superimposed on the goal image Ig displayed in the camera image display portion 901. The figures indicating the feature lines L(1) to L(N_{L}) are, for example, frames each displayed in a quadrangular shape. The frames are, for example, each indicated by a broken line. The feature lines L(n) are each a line indicating a boundary between regions, and extracted by, for example, Hough transform. N_{L} is the number of the extracted feature lines.

In step S103, the CPU 401 stands by for selection of any one of the feature lines L(1) to L(N_{L}) by the user. The figures indicating the feature lines L(1) to L(N_{L}) in the camera image display portion 901 can be selected by the user. When any one of the figures of the feature lines is selected by the user in the camera image display portion 901, the CPU 401 displays the selected figure in an emphasized manner as illustrated in FIG. 10B, and sets the feature line corresponding to the selected figure as a feature line to be set. That is, the user can select a feature line from the plurality of feature lines L(1) to L(N_{L}) via the UI image 900. The emphasized display of the figure includes, for example, displaying the figure in a thick line or displaying the figure in a different color from the figures of the other feature lines. In FIG. 10B, feature lines Lc1 and Lc2 are selected feature lines.

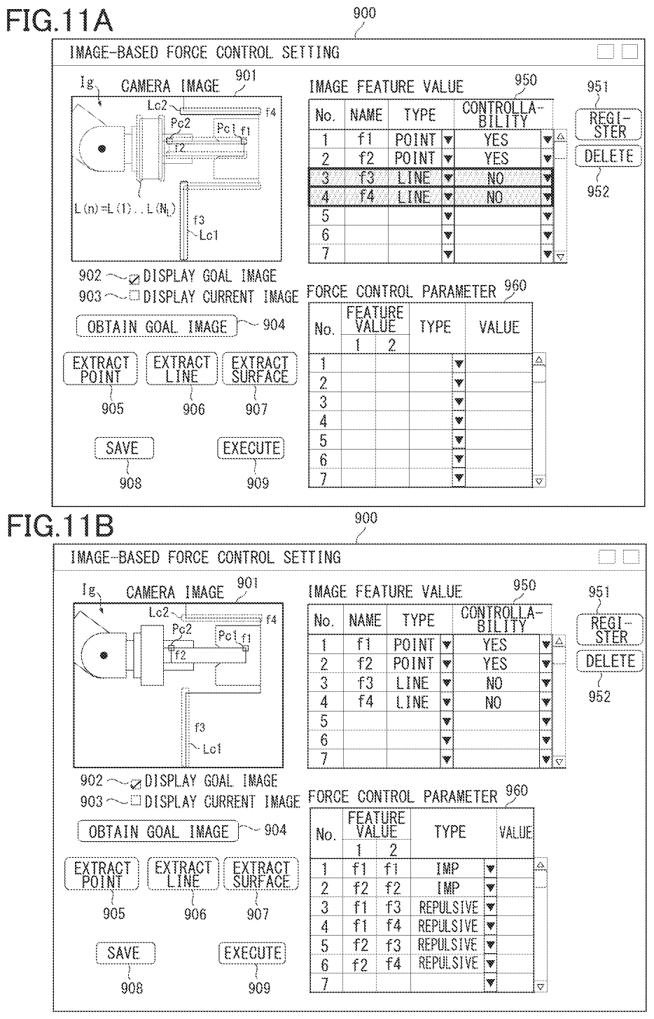

In step S104, the CPU 401 stands by for operation of the registration button 951 by the user. When the registration button 951 is operated by the user, the CPU 401 displays information of the selected feature lines Lc1 and Lc2 in the list display portion 950 as illustrated in FIG. 11A, and temporarily stores the information of the selected feature lines Lc1 and Lc2 in the RAM 403.

Here, in the camera image display portion 901, “f3” is displayed near the figure corresponding to the feature line Lc1, and “f4” is displayed near the figure corresponding to the feature line Lc2. In addition, since the registration button 951 has been operated in a state in which feature lines are selected as feature values, the CPU 401 automatically selects “Line”. The feature lines Lc1 and Lc2 are feature values associated with the workpiece fixing jig M1. Therefore, the user selects “No” as the controllability.

To be noted, if the deletion button 952 is operated in a state in which a registered feature value is selected, the CPU 401 stops emphasized display of and display in the list display portion 950 of the selected feature value, and deletes information thereof temporarily stored in the RAM 403.

As described above, in the case where registration of a feature value or feature values required for the assembly work is finished in step S105, the CPU 401 proceeds to processing of step S106. In the description below, the registered feature values Pc1, Pc2, Lc1, and Lc2 will be also referred to as feature values f1, f2, f3, and f4 in correspondence with the names thereof. In addition, in the case where the feature values f1, f2, f3, and f4 are not distinguished, the feature values f1, f2, f3, and f4 will be also each referred to as a feature value f. The feature values f1 and f2 in the goal image Ig are first feature portions corresponding to a control target object such as the workpiece W1, and the feature values f3 and f4 in the goal image Ig are second feature portions corresponding to an obstacle such as the workpiece fixing jig M1.

In step S106, the CPU 401 receives, in the parameter display portion 960, user input of force control parameters including dynamical characteristics of a virtual force acting on the feature value f registered in steps S102 to S105.

FIG. 11B illustrates an example of the force control parameters input in the parameter display portion 960. The force control parameters include, for example, information of a number, information of the name of the feature value with which the dynamical characteristics are associated, information of the type of the dynamical characteristics, and a numerical value corresponding to the type of the dynamical characteristics. The numerical value corresponding to the type of the dynamical characteristics is a first parameter or a second parameter that will be described later. In FIG. 11B, six input rows for the force control parameters of numbers “1” to “6” are illustrated as an example.

In the input row for the force control parameters of the number “1”, the user inputs “f1” as the name of the feature value with which the dynamical characteristics are associated, and “IMP” indicating impedance, that is, indicating an attractive force is input as the type of the dynamical characteristics, such that the workpiece W1 reaches the state of the goal image Ig. In addition, in the input row for the force control parameters of the number “2”, the user inputs “f2” as the name of the feature value with which the dynamical characteristics are associated, and “IMP” indicating impedance, that is, indicating an attractive force is input as the type of the dynamical characteristics, such that the workpiece W1 reaches the state of the goal image Ig.

To be noted, two fields “1” and “2” are fields for inputting names of feature values with which the dynamical characteristics are associated. The names “f1” to “f4” described above can be input to the fields “1” and “2”. The field “1” to which the name of a feature value is input corresponds to a captured image that is newly obtained, that is, a captured image Ic that will be described later, and the field “2” to which the name of a feature value is input corresponds to the goal image Ig. If the same name, for example, “f1” is input to both the fields “1” and “2”, the feature value f1 registered in the goal image Ig is associated with a feature value matching the feature value f1 among feature values extracted from the captured image newly obtained from the visual sensor 800. Similarly, if the same name, for example, “f2” is input to both the fields “1” and “2”, the feature value f2 registered in the goal image Ig is associated with a feature value matching the feature value f2 among feature values extracted from the captured image newly obtained from the visual sensor 800.

In addition, in the input rows for the force control parameters of the numbers “3” and “4”, information for associating the dynamical characteristics is input by the user such that the workpiece W1 avoids the workpiece fixing jig M1, that is, such that the feature value f1 receives a virtual repulsive force from the feature values f3 and f4. Similarly, in the input rows for the force control parameters of the numbers “5” and “6”, information for associating the dynamical characteristics is input by the user such that the workpiece W1 avoids the workpiece fixing jig M1, that is, such that the feature value f2 receives a virtual repulsive force from the feature values f3 and f4.

That is, in the input row for the force control parameters of the number “3”, the user inputs the name “f1” in the field “1” for inputting the name of the feature value, and inputs the name “f3” in the field “2” for inputting the name of the feature value. In addition, the user inputs “Repulsive” indicating a repulsive force as the type of the dynamical characteristics. In addition, in the input row for the force control parameters of the number “4”, the user inputs the name “f1” in the field “1” for inputting the name of the feature value, and inputs the name “f4” in the field “2” for inputting the name of the feature value. In addition, the user inputs “Repulsive” indicating a repulsive force as the type of the dynamical characteristics.

In addition, in the input row for the force control parameters of the number “5”, the user inputs the name “f2” in the field “1” for inputting the name of the feature value, and inputs the name “f3” in the field “2” for inputting the name of the feature value. In addition, the user inputs “Repulsive” indicating a repulsive force as the type of the dynamical characteristics. In addition, in the input row for the force control parameters of the number “6”, the user inputs the name “f2” in the field “1” for inputting the name of the feature value, and inputs the name “f4” in the field “2” for inputting the name of the feature value. In addition, the user inputs “Repulsive” indicating a repulsive force as the type of the dynamical characteristics.

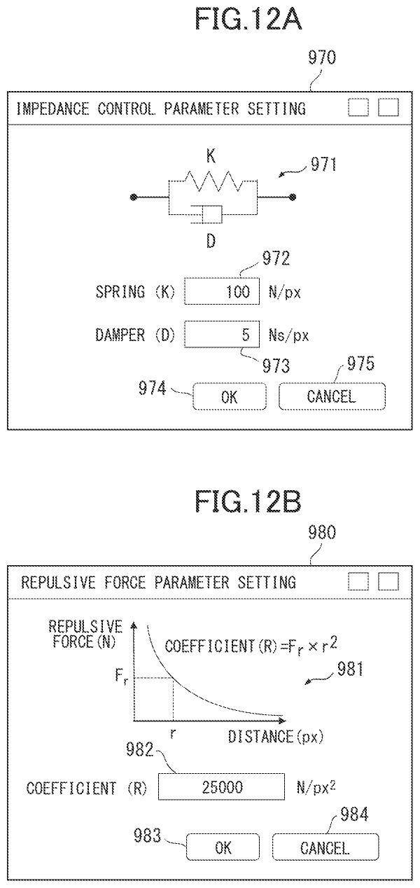

In addition, in the input row for the force control parameters of each of the numbers “1” to “6”, first parameters or second parameters that are values of the dynamical characteristics are input by the user. When a corresponding portion of the parameter display portion 960, that is, the input row is selected by the user, in the case where the type of the dynamical characteristics in the selected corresponding portion is “IMP”, the CPU 401 displays a UI image 970 illustrated in FIG. 12A corresponding to “IMP” on the display screen 601 of the display 600. In addition, in the case where the type of the dynamical characteristics in the selected corresponding portion is “Repulsive”, the CPU 401 displays a UI image 980 illustrated in FIG. 12B corresponding to “Repulsive” on the display screen 601 of the display 600. The UI images 970 and 980 are each an example of a first user interface image.

For example, in the force control parameters of the numbers “1” and “2”, the type of the dynamical characteristics is “IMP”. Therefore, when the input row of the force control parameters of the number “1” or “2” is selected in the parameter display portion 960, the CPU 401 displays the UI image 970 illustrated in FIG. 12A on the display screen 601 of the display 600.

The UI image 970 displays a model diagram 971 of mechanical impedance, a spring coefficient input portion 972, a damper coefficient input portion 973, an OK button 974, and a cancellation button 975. The user inputs a spring coefficient (K) in the spring coefficient input portion 972. The user inputs a damper coefficient (D) in the damper coefficient input portion 973.

When the OK button 974 is operated by the user, the CPU 401 temporarily stores values input in the spring coefficient input portion 972 and the damper coefficient input portion 973 in the RAM 403, and closes the UI image 970. When the cancellation button 975 is operated, the CPU 401 closes the UI image 970 without storing the values in the RAM 403. The spring coefficient (K) and the damper coefficient (D) are examples of first parameters. As described above, the CPU 401 receives setting of the spring coefficient (K) and the damper coefficient (D) via the UI image 970.

In addition, for example, in the force control parameters of the numbers “3” to “6”, the type of the dynamical characteristics is “Repulsive”. Therefore, when the input row of the force control parameters of any one of the numbers “3” or “6” is selected in the parameter display portion 960, the CPU 401 displays the UI image 980 illustrated in FIG. 12B on the display screen 601 of the display 600.

The UI image 980 displays a graph 981 indicating a relationship between the distance and the repulsive force, a repulsive force coefficient input portion 982, an OK button 983, and a cancellation button 984. The user inputs a repulsive force coefficient (R) in the repulsive force coefficient input portion 982.

When the OK button 983 is operated by the user, the CPU 401 temporarily stores a value input in the repulsive force coefficient input portion 982 in the RAM 403, and closes the UI image 980. When the cancellation button 984 is operated, the CPU 401 closes the UI image 980 without storing the value in the RAM 403. The repulsive force coefficient (R) is an example of a second parameter. As described above, the CPU 401 receives setting of the repulsive force coefficient (R) via the UI image 980.

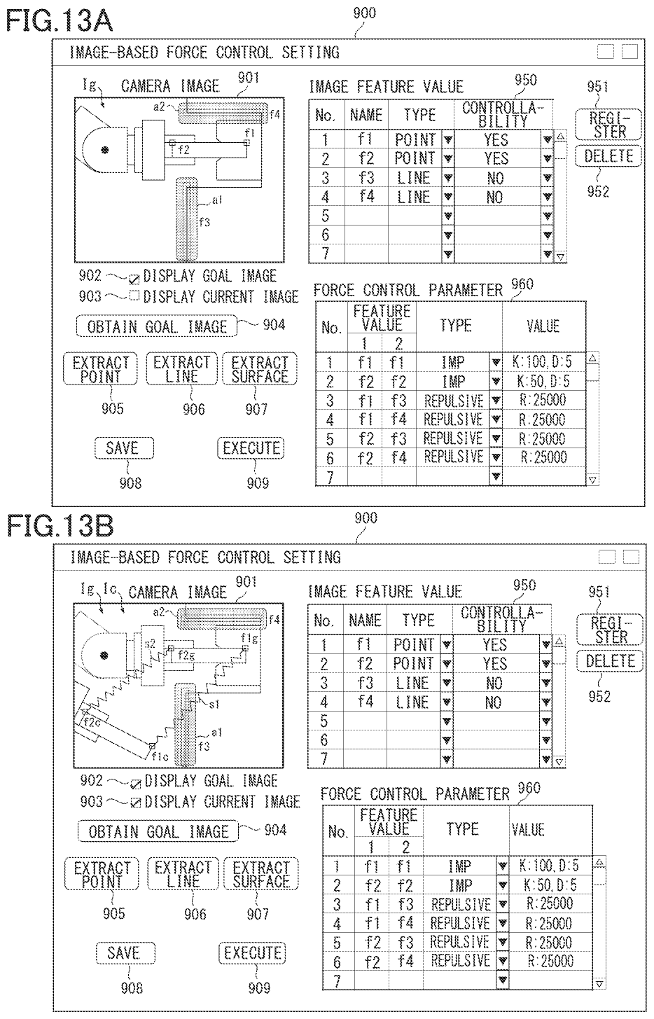

As described above, in step S106, force control parameters including dynamical characteristics of virtual force are registered. To be noted, the first parameter and the second parameter that are registered numerical values are displayed in the field of “Value” in the camera image display portion 901 as illustrated in FIG. 13A.

In addition, the CPU 401 displays figures indicating the dynamical characteristics of the registered virtual forces on the goal image Ig in the camera image display portion 901. Since the dynamical characteristics of the virtual forces in the force control parameters of the numbers “3” to “6” are “Repulsive” indicating a repulsive force, for example, repulsive regions a1 and a2 are displayed with hatching as illustrated in FIG. 13A. The repulsive regions a1 and a2 indicate regions where a virtual repulsive force generated by the feature values f3 and f4 is, for example, 10 N.

In step S107, in the case where registration of the dynamical characteristics of virtual force to the feature value f is finished, that is, in the case where the result of step S107 is YES, the CPU 401 proceeds to processing of step S108, and otherwise, that is, in the case where the result of step S107 is NO, the CPU 401 returns to processing of step S106.

In step S108, when the saving button 908 is operated by the user, the CPU 401 stores, as setting information PS and in the HDD 404, information including the feature value f and the force control parameters that have been registered. That is, the setting information PS including the feature value f and the force control parameters is set. The setting flow is finished in this manner. To be noted, in the present embodiment, setting the information refers to storing the information in a storage such as the HDD 404.

The user can recognize whether or not the setting of the assembly work of the workpieces have been performed as intended, by looking at the UT image 900. As illustrated in FIG. 13B, when the current image display checkbox 903 is checked by the user, the CPU 401 displays a new captured image Ic obtained from the visual sensor 800 in the camera image display portion 901 such that the goal image Ig and the captured image Ic overlap. For example, the goal image Ig is displayed on the captured image Ic in the camera image display portion 901 in a state in which the goal image Ig is translucent.

Here, the feature values f1 and f2 correspond to the workpiece W1 that is a control target object, and the feature values f3 and f4 correspond to the workpiece fixing jig M1 that is an obstacle. The CPU 401 obtains feature values matching the feature values f1 and f2 by, for example, pattern matching processing in the captured image Ic that is newly obtained.

The CPU 401 displays the feature values f1 and f2 in the goal image Ig as character images “f1g” and “f2g” in the camera image display portion 901 with quadrangular figures. In the description below, the feature values f1 and f2 in the goal image Ig will be denoted by the same reference signs as the character images “f1g” and “f2g”, that is, will be referred to as feature values f1g and f2g. As described above, the feature values f1g and f2g are examples of first feature portions. The goal image Ig, the feature values f1g, f2g, f3, f4, and the like are information that has been already set.

Similarly, the CPU 401 displays the feature values matching the feature values f1g and f2g in the captured image Ic as character images “f1c” and “f2c” in the camera image display portion 901 with quadrangular figures. In the description below, the feature values matching the feature values f1g and f2g in the captured image Ic will be denoted by the same reference signs as the character images “f1c” and “f2c”, that is, will be referred to as feature values f1c and f2c. The feature values f1c and f2c are examples of third feature portions.

The feature value f1g and the feature value f1c are associated with each other with regard to virtual impedance characteristics, that is, virtual attractive force in the setting information PS. The feature value f2g and the feature value f2c are associated with each other with regard to virtual impedance characteristics, that is, virtual attractive force in the setting information PS. That is, the CPU 401 sets (defines) virtual attractive force acting between the feature values f1g and f1c on the basis of the setting information PS, and sets (defines) virtual attractive force acting between the feature values f2g and f2c on the basis of the setting information PS. The CPU 401 displays the virtual attractive force between the feature values f1g and f1c as a figure s1 in the camera image display portion 901. In addition, the CPU 401 displays the virtual attractive force between the feature values f2g and f2c as a figure s2 in the camera image display portion 901. The figures s1 and s2 are each a figure that the user can instinctively understand as an attractive force, for example, a figure of a triangular wave shape, that is, a spring figure. The figure s1 is a figure interconnecting the figure indicating the feature value f1g and the figure indicating the feature value f1c. The figure s2 is a figure interconnecting the figure indicating the feature value f2g and the figure indicating the feature value f2c. In the description below, the virtual attractive force between the feature value fig and the feature value f1c will be denoted by the same reference sign as the figure s1, that is, will be referred to as an attractive force s1. In addition, the virtual attractive force between the feature value f2g and the feature value f2c will be denoted by the same reference sign as the figure s2, that is, will be referred to as an attractive force s2. The attractive force s1 is obtained by using parameters set in accordance with the force control parameters of the number “1”, and the attractive force s2 is obtained by using parameters set in accordance with the force control parameters of the number “2”.

In addition, the feature value f3 and the feature value f1c are associated with each other with regard to a virtual repulsive force in the setting information PS, and the feature value f4 and the feature value f1c are associated with each other with regard to a virtual repulsive force in the setting information PS. In addition, the feature value f3 and the feature value f2c are associated with each other with regard to a virtual repulsive force in the setting information PS, and the feature value f4 and the feature value f2c are associated with each other with regard to a virtual repulsive force in the setting information PS. That is, the CPU 401 sets (defines) virtual repulsive force acting between the feature values f3 and f1c on the basis of the setting information PS, and sets (defines) virtual repulsive force acting between the feature values f4 and f1c on the basis of the setting information PS. Similarly, the CPU 401 sets (defines) virtual repulsive force acting between the feature values f3 and f2c on the basis of the setting information PS, and sets (defines) virtual repulsive force acting between the feature values f4 and f2c on the basis of the setting information PS. A method for calculating these virtual forces, that is, the virtual attractive force and the virtual repulsive force will be described later.

The user can instruct the control apparatus 400 to start the assembly work via the UI image 900 or the input device 500. In the case of using the UI image 900, the user can instruct the start of work by operating the execution button 909. In the case of using the input device 500, the user can instruct the start of work by specifying the setting information PS by the input device 500.

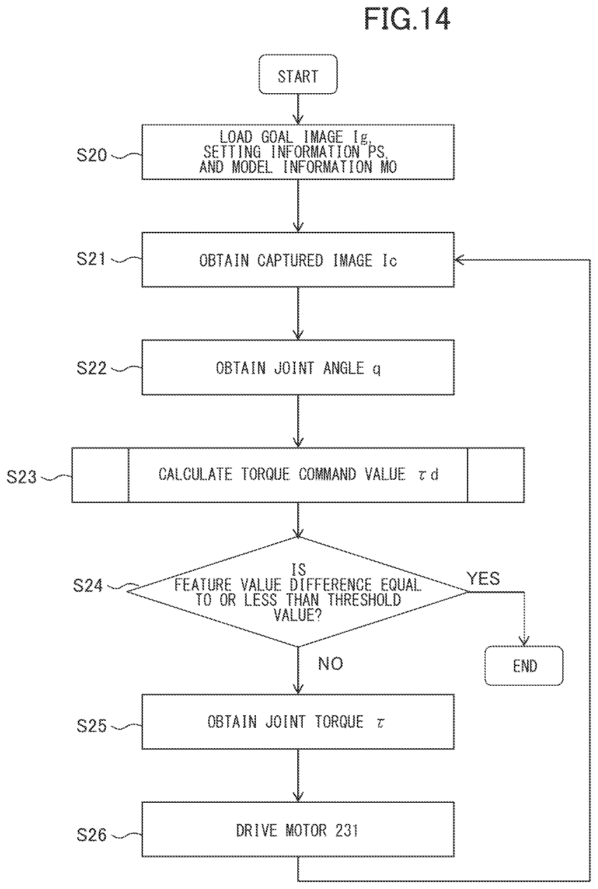

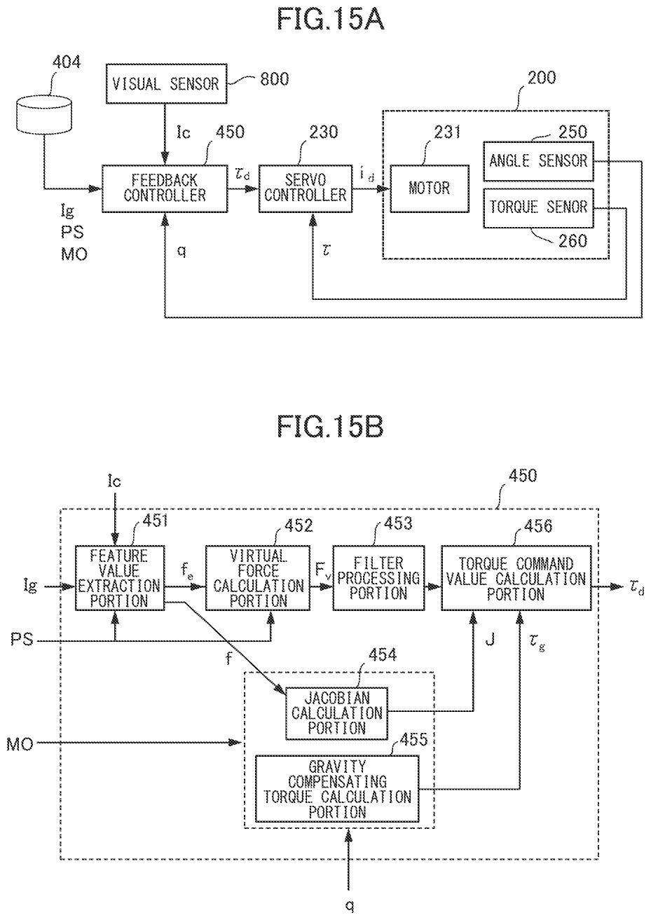

FIG. 14 is a flowchart illustrating force control for performing the assembly work according to the present embodiment. When the start of work is instructed, the CPU 401 and the servo controller 230 execute processing according to the flowchart illustrated in FIG. 14. FIGS. 15A and 15B are control block diagrams according to the embodiment. Here, the CPU 401 functions as a feedback controller 450 illustrated in FIG. 15A by executing the program 430. In the present embodiment, the feedback controller 450 and the servo controller 230 are examples of controllers, that is, processors, and force control of the robot 100 can be performed by cooperation of the feedback controller 450 and the servo controller 230.

In the present embodiment, a minor loop in which a torque detection value τ of the torque sensor 260 is fed back is formed in the servo controller 230. In addition, a major loop in which the captured image Ic of the visual sensor 800 and an angle detection value q of the angle sensor 250 are fed back is formed in the feedback controller 450. By this major loop, full-closed loop control that controls the robot 100 such that the deviation of the captured image Ic from the goal image Ig becomes small is performed.

To be noted, the initial state of the workpiece W1 in which the force control is started is a state illustrated in FIG. 4A. That is, the control apparatus 400 and the servo controller 230 control the robot 100 by position control until the state of FIG. 4A is reached. Position control is control based on an angle command value and the angle detection value q. The angle detection value q is made closer to the angle command value by the position control. When the state of FIG. 4A is reached, the control apparatus 400 and the servo controller 230 start force control of the robot 100.

In step S20, the feedback controller 450 loads the goal image Ig, the setting information PS, and model information MO stored in the HDD 404. The model information MO includes information of link parameters used for kinematic calculation and dynamical calculation of the robot arm 200, and information of a dynamical model.

In step S21, the feedback controller 450 obtains the captured image Ic generated by imaging by the visual sensor 800 from the visual sensor 800.

In addition, in step S22, the feedback controller 450 obtains the angle detection value, that is, a joint angle q of each of the joints J₁ to J₆ of the robot arm 200 via the servo controller 230. To be noted, the joint angle q is an angle value obtained by converting, on the basis of the reduction ratio of the unillustrated reduction gear and the like, the angle obtained by the angle sensor 250, but illustration of a conversion portion that performs this conversion processing is omitted in FIG. 15A. The function of this conversion portion may be included in the control apparatus 400, or in the servo controller 230.

In step S23, the feedback controller 450 calculates a torque command value τ_{d}. FIG. 15B is a block diagram of the processing by the feedback controller 450.

As illustrated in FIG. 15B, the feedback controller 450 includes a feature value extraction portion 451, a virtual force calculation portion 452, a filter processing portion 453, a Jacobian calculation portion 454, a gravity compensating torque calculation portion 455, and a torque command value calculation portion 456.

The feature value extraction portion 451 extracts a feature value f set in the setting information PS from each of the goal image Ig and the captured image Ic on the basis of the feature value descriptor. For example, as illustrated in FIG. 13B, the feature value extraction portion 451 extracts the feature values f1g, f2g, f3, and f4 from the goal image Ig, and extracts the feature values f1c and f2c from the captured image Ic. To be noted, since the feature values f1g, f2g, f3, and f4 have been already set, information (data) that is loaded may be used. The feature values f1g and f2g are examples of first feature portions, the feature values f3 and f4 are examples of second feature portions, and the feature values f1c and f2c are examples of third feature portions.

The feature value extraction portion 451 calculates a vector of a feature value difference fₑ for which the dynamical relationship of virtual forces is set. For example, a vector of a feature value difference fₑ₁ corresponding to the force control parameters of the number “1” is calculated in accordance with the following formula (1)

$${f}_{e 1} = {f}_{1 g} - {f}_{1 c} = \vert \begin{matrix}{u}_{1 g} - {u}_{1 c} \\ {v}_{1 g} - {v}_{1 c}\end{matrix} \vert \qquad ( 1 )$$

Here, bold characters each represent a vector or a matrix. The vector of f_{1c} is the position ([u_{1c} v_{1c}]^{T}) in the image of the feature value extracted from the captured image Ic. In addition, the vector of f_{1g} is the position ([u_{1g} v_{1g}]^{T}) in the image of the feature value extracted from the goal image Ig. The superscript “T” indicates transposition of a matrix or a vector.

The feature value extraction portion 451 performs similar calculation also for feature value differences corresponding to the force control parameters of the other numbers included in the setting information PS. In the example of FIG. 13B, since there are six sets of the force control parameters, the vector of difference fₑ is a twelve-dimensional vector, and fₑ is expressed by fₑ=[fₑ₁^{T} . . . fₑ₆^{T}]^{T}.

The feature value extraction portion 451 transmits the vector of the difference fₑ calculated in this manner to the virtual force calculation portion 452. To be noted, in the case where the associated feature values are a combination of a point and a line as in the force control parameters of the numbers “3” to “6”, the shortest distance therebetween is calculated as the feature value difference.

The virtual force calculation portion 452 calculates a vector of a virtual force Fᵥ acting between feature values on the basis of the feature value difference fₑ and the force control parameters included in the setting information PS.

For example, the vector of a virtual force Fᵥ₁ corresponding to the force control parameters of the number “1” in which virtual impedance characteristics are set is calculated in accordance with the following formula (2).

Fᵥ₁=K_{d1}fₑ₁+D_{d1}\dot{f}ₑ₁ (2)

In the formula (2), K_{d1} and D_{d1} are scholar values respectively indicating a spring coefficient and a damper coefficient in the virtual impedance characteristics corresponding to the force control parameters of the number “1”.

In addition, the vector of a virtual force Fᵥ₃ corresponding to the force control parameters of the number “3” in which virtual repulsive force characteristics are set is calculated in accordance with the following formula (3).

$${F}_{v 3} = \frac{{R}_{3}}{{‖ {f}_{e 3} ‖}^{3}} {f}_{e 3} \qquad ( 3 )$$

In the formula (3), R₃ represents a coefficient associating a distance and a repulsive force in the virtual repulsive force corresponding to the force control parameters of the number “3”.

The feature value extraction portion 451 performs similar calculation also for the virtual forces corresponding to the force control parameters of the other numbers included in the setting information PS. In the example of FIG. 13B, since there are six sets of the force control parameters, the vector of virtual force Fᵥ is a twelve-dimensional vector, and Fᵥ is expressed by Fᵥ=[Fᵥ₁^{T} . . . Fᵥ₆^{T}]^{T}. The feature value extraction portion 451 transmits the vector of the virtual force Fᵥ calculated in this manner to the filter processing portion 453.

As described above, the feature value extraction portion 451 obtains the vector of the virtual force Fᵥ as the information about force by comparing the goal image Ig with the captured image Ic. That is, the feature value extraction portion 451 obtains a virtual attractive force Fᵥ₁ based on the relationship between the feature value f1c and the feature value f1g, and a virtual attractive force Fᵥ₂ based on the relationship between the feature value f2c and the feature value f2g. In addition, the feature value extraction portion 451 obtains a virtual repulsive force Fᵥ₃ based on the relationship between the feature value f1c and the feature value f3, a virtual repulsive force Fᵥ₄ based on the relationship between the feature value f1c and the feature value f4, a virtual repulsive force Fᵥ₅ based on the relationship between the feature value f2c and the feature value f3, and a virtual repulsive force Fᵥ₆ based on the relationship between the feature value f2c and the feature value f4.

The filter processing portion 453 performs predetermined filter processing on each element of the vector of the virtual force Fᵥ. The filter used for the filter processing is a digital filter obtained by discretizing a transfer function expressed by the following formula (4) by bilinear transformation or the like.

$$\frac{{s}^{2} + 2 d ζ {w}_{n} s + {w}_{n}^{2}}{{s}^{2} + 2 ζ {w}_{n} s + {w}_{n}} \qquad ( 4 )$$

This transfer function is a secondary notch filter, has an effect of reducing the gain in a predetermined frequency range, and is used as a method for stabilizing the control. Here, s represents a differential operator, ωₙ represents a central frequency of the notch, ζ represents the width of the notch, and d represents a variable determining the depth of the notch. The virtual force Fᵥ subjected to filter processing is transmitted to the torque command value calculation portion 456.

The Jacobian calculation portion 454 calculates a matrix of an image Jacobian J_{img} and a matrix of a robot Jacobian Jᵣ for each feature value f The image Jacobian J_{img} is a matrix of 8 rows×6 columns associating the amount of infinitesimal displacement of the coordinate system Tₑ set for the robot hand 300 with the amount of infinitesimal displacement of the feature value f. The robot Jacobian Jᵣ is a matrix of 6 rows×6 columns associating the amount of infinitesimal displacement of each of the joints J₁ to J₆ of the robot arm 200 with the amount of infinitesimal displacement of the coordinate system Tₑ set for the robot hand 300. The image Jacobian J_{img} and the robot Jacobian Jᵣ are defined in accordance with the following formula (5).

$${J}_{img} = \frac{\partial f}{\partial {x}_{e}^{τ}} , {J}_{r} = \frac{\partial {x}_{e}}{\partial {q}^{τ}} \qquad ( 5 )$$

Here, xₑ represents a position vector xₑ=[Xₑ Yₑ Zₑ αₑ βₑ γₑ]^{T} of the coordinate system Tₑ of a degree of freedom of 6 in the coordinate system Tₒ. q represents a joint angle vector q=[q₁ . . . q₆]^{T} of the joints J₁ to J₆ of the robot arm 200.

The Jacobian calculation portion 454 calculates a composite Jacobian J that is a matrix of 8 rows×6 columns obtained by combining the image Jacobian J_{img} and the robot Jacobian Jᵣ by calculating the inner product thereof. That is, the composite Jacobian J is a matrix associating the motion of the robot arm 200 with the motion of the feature value.

The gravity compensating torque calculation portion 455 calculates, on the basis of the model information MO and the joint angle q of each of the joints J₁ to J₆ of the robot arm 200, a gravity compensating torque τ_{g} balanced with an estimated value of gravity torque generated by gravity at each of the joints J₁ to J₆ of the robot arm 200. The gravity compensating torque τ_{g} is calculated by, for example, deriving an equation of motion by the Newton-Euler method.

The torque command value calculation portion 456 calculates a torque command value τ_{d} in accordance with the following formula (6) on the basis of the virtual force Fᵥ subjected to filter processing, the composite Jacobian J, and the gravity compensating torque τ_{g}.

τ_{d}=τ_{g}+J^{T}Fᵥ (6)

As described above, the torque command value calculation portion 456 obtains the torque command value τ_{d} for force control of the robot 100 on the basis of the virtual force Fᵥ.

In step S24, the feedback controller 450 determines whether or not each element included in the feature value difference fₑ is equal to or less than a predetermined threshold value. In the case where all the elements are equal to or less than the predetermined threshold value, that is, in the case where the result of step S24 is YES, the feedback controller 450 and the servo controller 230 finish the processing. Otherwise, that is, in the case where the result of step S24 is NO, the feedback controller 450 proceeds to processing of step S25. As the predetermined threshold value, for example, 3 pixels is set for the force control parameters of the numbers “1” and “2”. To be noted, the pixel is a unit corresponding to one pixel of the image.

In step S25, the feedback controller 450 obtains the torque detection value τ from the torque sensor 260 of each of the joints J₁ to J₆ of the robot arm 200.

In step S26, the servo controller 230 calculates a current command value of a current to be supplied to the motor 231 of each of the joints J₁ to J₆ of the robot arm 200 such that the torque detection value τ follows the torque command value τ_{d}. Then, the servo controller 230 supplies a current i_{d} to the motor 231 on the basis of the current command value, and thus drives the motor 231. That is, the servo controller 230 performs torque control based on the difference between the torque value τ and the torque command value τ_{d}.

When the processing of step S26 is finished, the feedback controller 450 returns to the processing of step S21. As described above, the processing of steps S21 to S26 is repeatedly executed each time a new captured image Ic is obtained by the feedback controller 450. By the control processing described above, the control apparatus 400 and the servo controller 230 can control the robot arm 200 on the basis of virtual dynamical characteristics set by the user in the feature value space.

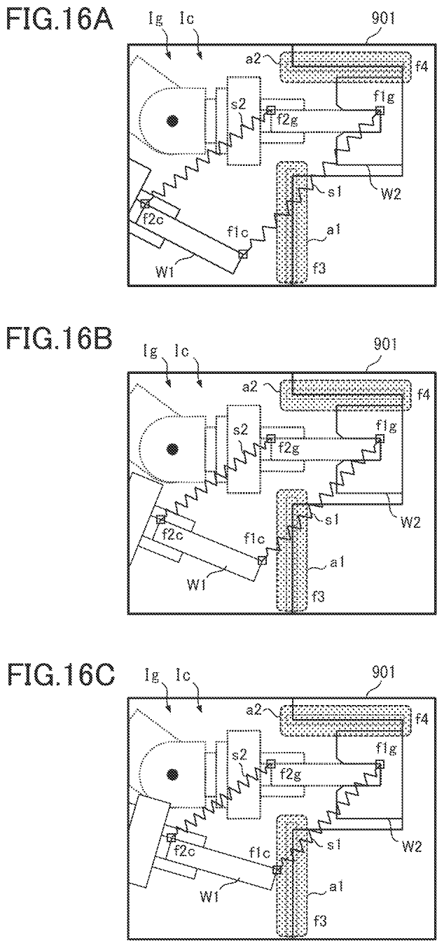

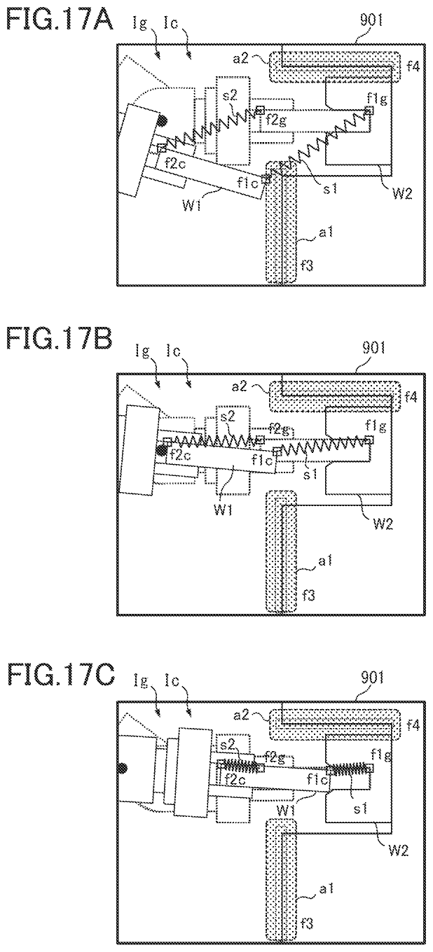

Next, a process of coupling the workpiece W1 to the workpiece W2 in accordance with the setting information PS will be described in detail. FIGS. 16A to 17C are each an explanatory diagram of the camera image display portion 901 displaying the state of the assembly work according to the embodiment.

First, when the workpiece W1 is in the initial state, the positional relationship between the workpiece W1, the workpiece W2, the workpiece fixing jig M1, and feature values f associated therewith is as illustrated in FIG. 16A.

When the control apparatus 400 starts control of the robot arm 200, the feature values f1c and f1g attract each other, and the feature values f2c and f2g attract each other, due to the effect of the virtual impedance characteristics corresponding to the force control parameters of the numbers “1” and “2”. Therefore, as illustrated in FIG. 16B, the feature value f1c approaches the feature value f1g, and the feature value f2c approaches the feature value f2g.

When the feature value f1c reaches a repulsive region a1 as illustrated in FIG. 16C, the workpiece W1 behaves as if the workpiece W1 is in contact with an invisible wall before coming into contact with the workpiece fixing jig M1, due to the effect of the characteristics of the virtual repulsive force corresponding to the force control parameters of the number “3”. At this time, due to the effect of the characteristics of the virtual impedance corresponding to the force control parameters of the numbers “1” and “2”, the action of the workpieces W1 and W2 attracting each other is continued. Therefore, as illustrated in FIG. 17A, the workpiece W1 slides along the outer frame of the repulsive region a1 such that the feature value f1c approaches the feature value f1g and the feature value f2c approaches the feature value f2g. Therefore, a situation in which the workpiece W1 collides with the workpiece fixing jig M1 can be avoided.

As illustrated in FIG. 17B, when the feature value f1c passes the repulsive region a1, the workpiece W1 starts moving in the X-axis direction of the coordinate system Tₒ. Then, as illustrated in FIG. 17C, the distal end of the workpiece W1 comes into contact with the entrance of the workpiece W2.

Then, due to the effect of the virtual impedance characteristics corresponding to the force control parameters of the numbers “1” and “2”, the workpiece W1 follows the shape of the workpiece W2, and when all the components of the feature value differences fₑ₁ and fₑ₂ are equal to or less than 3 pixels, the control apparatus 400 finishes the assembly work. As a result of this, a product in which the workpiece W1 is coupled to the workpiece W2 is manufactured.

As described above, as a result of the feedback controller 450 and the servo controller 230 performing force control based on the difference between the goal image Ig and the captured image Ic, the posture of the robot 100 is made closer to the goal posture in which the goal image Ig has been captured. That is, the position and orientation of the workpiece W1 is made closer to the position and orientation in the goal image Ig. Then, the coupling of the workpiece W1 is completed when the posture of the robot 100 roughly matches the goal posture.

As described above, according to the present embodiment, the robot 100 is controlled such that virtual force acts between the feature values f1c and f2c extracted from the captured image Ic and the feature values f1g, f2g, f3, and f4 that have been set. Therefore, a work based on force can be set in the feature value space, and thus the workability for the robot 100 can be improved.

For example, virtual attractive force can be set for the feature values f1g and f2g associated with the workpiece W1 that is a control target object, and virtual repulsive force can be set for the feature values f3 and f4 associated with the workpiece fixing jig M1 that is an obstacle. Therefore, a work involving contact such as the assembly work and a different operation such as avoiding the obstacle can be performed at the same time. As a result of this, the workpiece W1 being caught by an obstacle such as the workpiece fixing jig M1 can be reduced, thus the frequency of occurrence of a failure of assembly can be reduced, and therefore the workability for the robot 100 can be improved.

According to the present disclosure, the workability for the robot can be improved.

The present disclosure is not limited to the embodiments described above, and embodiments can be modified in many ways within the technical concept of the present disclosure. In addition, the effects described in the embodiments are merely enumeration of the most preferable effects that can be obtained from embodiments of the present disclosure, and effects of embodiments of the present disclosure are not limited to those described in the embodiments.

Although a case where the feedback controller 450 is part of functions of the CPU 401 and the servo controller 230 is constituted by a device different from the CPU 401 has been described in the above embodiment, the configuration is not limited to this. A configuration in which the CPU 401 realizes part or all of the functions of the servo controller 230 on the basis of the program 430 may be employed.

In addition, although the control apparatus 400 and the display 600 are used for displaying the UI image 900, receiving user input, and the like in the above embodiment, the configuration is not limited to this. For example, an electronic device including a CPU and a display device such as a display may be additionally used. The electronic device may be an information processing apparatus such as a desktop personal computer: desktop PC, a laptop PC, a tablet PC, or a smartphone. In addition, if the input device 500 is a teaching pendant including a display device, the display device may display the UI image.

In addition, although a case where the robot arm 200 is a vertically-articulated robot arm has been described in the above embodiment, the configuration is not limited to this. Various robot arms such as horizontally-articulated robot arms, parallel link robot arms, and orthogonal robots may be the robot arm 200.

In addition, although a case where the robot hand 300 is attached to the robot arm 200 has been described in the above embodiment, the configuration is not limited to this. A holding mechanism capable of holding a held object such as a workpiece may be attached to the robot arm 200 as an end effector. Examples of the holding mechanism include a mechanism that holds the workpiece by suction attraction. In addition, a tool for processing a workpiece or the like may be attached to the robot arm 200 as an end effector.

In addition, although a robot is used in the above embodiment, the configuration is not limited to this. For example, the present disclosure is also applicable to a machine capable of automatically performing extension, contraction, bending, vertical movement, horizontal movement, turning, or a composite operation of these on the basis of information in a storage device provided in a control apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-71245, filed Apr. 25, 2022, which is hereby incorporated by reference herein in its entirety.

What is claimed is:

1. A robot apparatus comprising:
a robot;
an image pickup portion; and
a controller configured to control the robot,
wherein the controller obtains information about force by comparing a predetermined image with a captured image obtained by the image pickup portion imaging the robot, and performs force control of the robot on a basis of the information about force.

2. The robot apparatus according to claim 1,
wherein the predetermined image is an image obtained by imaging the robot that is in a predetermined posture, and
the controller makes a posture of the robot closer to the predetermined posture by the force control.

3. The robot apparatus according to claim 1,
wherein the predetermined image includes a first feature portion corresponding to a control target object, and a second feature portion corresponding to an obstacle, and
the controller
obtains a third feature portion corresponding to the control target object from the captured image, and
obtains the information about force on a basis of a relationship between the third feature portion and the first feature portion and a relationship between the third feature portion and the second feature portion.

4. The robot apparatus according to claim 3, wherein the control target object is the robot or a held object held by the robot.

5. The robot apparatus according to claim 3, wherein the controller sets, as the information about force, a virtual attractive force acting between the third feature portion and the first feature portion, and a virtual repulsive force acting between the third feature portion and the second feature portion.

6. The robot apparatus according to claim 5, wherein the controller sets the virtual attractive force by using a first parameter, and sets the virtual repulsive force by using a second parameter.

7. The robot apparatus according to claim 6, wherein the controller displays a first user interface image for receiving setting of the first parameter and the second parameter on a display portion.

8. The robot apparatus according to claim 3, wherein the controller displays a second user interface image for receiving setting of the first feature portion and the second feature portion on a display portion.

9. The robot apparatus according to claim 8, wherein the controller displays the predetermined image in the second user interface image.

10. The robot apparatus according to claim 9, wherein the controller displays, in the second user interface image, a button for obtaining a plurality of feature candidates serving as candidates of the first feature portion and the second feature portion from the predetermined image.

11. The robot apparatus according to claim 10, wherein in a case where the button is operated, the controller displays, on the predetermined image displayed in the second user interface image, figures respectively corresponding to the plurality of feature candidates such that a user is capable of selecting the first feature portion and the second feature portion to be set from among the plurality of feature candidates.

12. The robot apparatus according to claim 9, wherein the controller displays, on the predetermined image displayed in the second user interface image, figures respectively corresponding to the first feature portion and the second feature portion that have been already set.

13. The robot apparatus according to claim 8, wherein the controller displays the predetermined image and the captured image in an overlapping state in the second user interface image.

14. A method for controlling a robot apparatus, the method comprising:
obtaining information about force by comparing a predetermined image with a captured image obtained by an image pickup portion imaging a robot; and
performing force control of the robot on a basis of the information about force.

15. An image processing apparatus configured to obtain information about force for performing force control of a robot, the image processing apparatus comprising:
a controller configured to obtain the information about force by comparing a predetermined image with a captured image obtained by an image pickup portion imaging the robot.

16. An image processing method for obtaining information about force for performing force control of a robot, the image processing method comprising:
obtaining the information about force by comparing a predetermined image with a captured image obtained by an image pickup portion imaging the robot.

17. A method for manufacturing a product by using the robot apparatus according to claim 1.

18. A non-transitory computer-readable recording medium storing a program for causing a computer to execute the method according to claim 14.
